(19) United States
(12) Patent Application Publication
(10) Pub. No.: US 2009/0254416 A1
(43) Pub. Date: Oct. 8, 2009

(54) Method and system for presenting advertisements targeted at passersby

(75) Inventor: Jagadeshwar R. Nomula, Sunnyvale, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/099,736

(22) Filed: Apr. 8, 2008

(51) Int. Cl. G06Q 30/00; H04B 7/00

(52) U.S. Cl. 705/10; 705/14; 455/41.2; 340/686.6

(57) ABSTRACT

A system and method which may allow advertisers to target advertisements on passersby and use advertising costs more effectively. An information acquiring device in or close to an electronic display device may receive identity information of a passerby from his/her wireless communication device, such as a telecommunication device. The identity information may include the passerby's phone number or name, the wireless telecommunication device's IP address, or cookie files. The information acquiring device may use the received identity information to obtain detailed information about the passerby which may indicate what the passerby might be interested in. The detailed information may include browsing history information or demographic information. The detailed information may then be forwarded to an advertisement server which may select an advertisement targeted at the passerby according to the detailed information, and have the selected advertisement shown on the electronic display device.

### BACKGROUND

1. Field of the Invention

The present invention relates generally to advertisement targeting, and more particularly to a method and system for presenting, on an electronic display device, advertisements targeted at passersby.

2. Description of Related Art

Nowadays, business facilities (e.g., gas stations, stores, airports and hotels) often use electronic display devices (e.g., LCDs, billboards and closed circuit TVs) to display advertisements to passersby. An advertiser (e.g., Coca Cola™) may pay a certain amount of money to the owner of an electronic display device to display an advertisement a certain number of times or over a certain period of time. One problem of such an approach is that neither the owner of the electronic display device nor the advertiser has enough information about the passersby, or knows what advertisements the passersby might be interested in. Consequently, the advertising is not really targeted, and as a result, advertisers may waste their money.

Therefore, it may be desirable to provide a system and method which may help advertisers to manage their advertising costs more effectively by obtaining information about passersby and presenting targeted advertisements accordingly.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a system for presenting advertisements targeted at passersby according to one embodiment of the present invention.

FIG. 2 illustrates a browsing history information database according to one embodiment of the present invention.

FIG. 3 illustrates a system for presenting advertisements targeted at passersby according to one embodiment of the present invention.

FIG. 4 illustrates a flow chart of a method for presenting advertisements targeted at passersby according to one embodiment of the present invention.

### DETAILED DESCRIPTION

The present invention provides a system and method which may allow advertisers to target advertisements at passersby. With the development of wireless telecommunication technologies, more and more people are using wireless telecommunication devices. Examples of such wireless telecommunication devices may include a mobile phone and a smartphone, and also portable music players and other personal electronic devices, such as an iPod Touch™. In addition to base stations in its own wireless telecommunication system, such wireless telecommunication devices may communicate with other electronic devices via a wireless personal area network (PAN) as used in the definition of Bluetooth and accompanying standards, Wi-Fi (according to one or more of the existing and/or developing standards), WiMax, iRda, or EDGE, EV-DO, high-speed downlink packet access (HSDPA) or one of the other wireless communication technologies, or one of the existing and emerging 802.11 and/or 802.16 wireless standards. This list is intended to be illustrative, not exhaustive.

An information acquiring device in or close to an electronic display device may receive identity information of a passerby from his/her wireless telecommunication device via one of the just-mentioned technologies. The identity information may include the passerby's phone number, name, the wireless telecommunication device's IP address, or cookie files and may be collected with a passerby's permission. The information acquiring device may use the received identity information to obtain detailed information about the passerby which may indicate what the passerby might be interested in. The detailed information may include browsing history information or demographic information and may be collected with a passerby's permission. The detailed information may then be forwarded to an advertising server which may select an advertisement targeted at the passerby according to the detailed information, and have the selected advertisement shown on the electronic display device. Consequently, this invention may allow advertisers to target their advertisements at passersby, and use advertising costs more effectively. Advantages of the present invention will become apparent from the following detailed description.

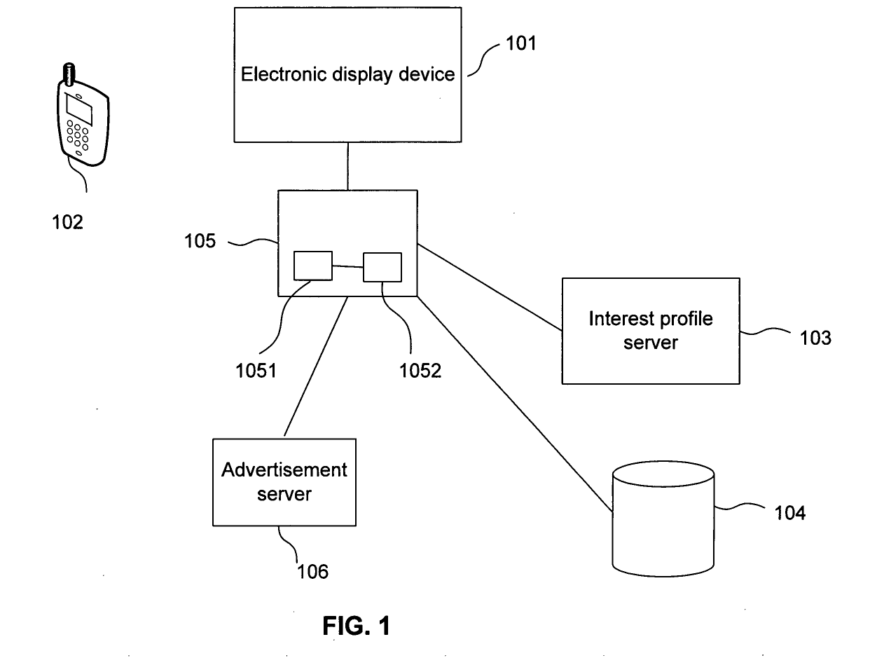

FIG. 1 illustrates a system for presenting advertisements targeted at passersby according to one embodiment of the present invention. An electronic display device 101 may be placed at a gas station, a hotel, a restaurant, a hospital, an airport or any other business facilities to display advertisements to passersby. The electronic display device 101 may be an LCD, a billboard or a closed circuit TV and may not be operated by passersby. An advertiser may pay the owner of the electronic display device 101 for displaying the advertiser's advertisements.

A wireless telecommunication device 102 may be a mobile phone or a smartphone. It may communicate with electronic devices outside the wireless telecommunication network it belongs to via one of the wireless technologies mentioned earlier. The wireless telecommunication device 102 may transmit identity information regularly, e.g., every 5 seconds. If the wireless telecommunication device 102 does not have Internet access capabilities, the identity information may be the passerby's mobile phone number or name, or the name of the carrier of the phone service (e.g., AT&T or T-Mobile). If the wireless telecommunication device 102 has Internet access capabilities, the identity information may be cookie files, which may include the wireless telecommunication device's IP address, and/or web pages recently browsed. In one embodiment, the wireless telecommunication device 102 may provide its users options about what information may be transmitted, and/or what type of wireless network may be used for the transmission.

The wireless telecommunication device 102 may be running some form of software, e.g. Yahoo! Go™, which may make a user's registration information available for use in providing targeted advertising according to the invention.

An interest profile server 103 may be coupled to a number of Internet servers, each of which may control the operation of a website or a blog, to collect information about Internet users and compile their interest profiles. The interest profile may include browsing history information or demographic information of an Internet user. The Internet users may include a passerby of the electronic display device 101. The interest profile server 103 may store the interest profile of each Internet user as a data log in a database 1031.

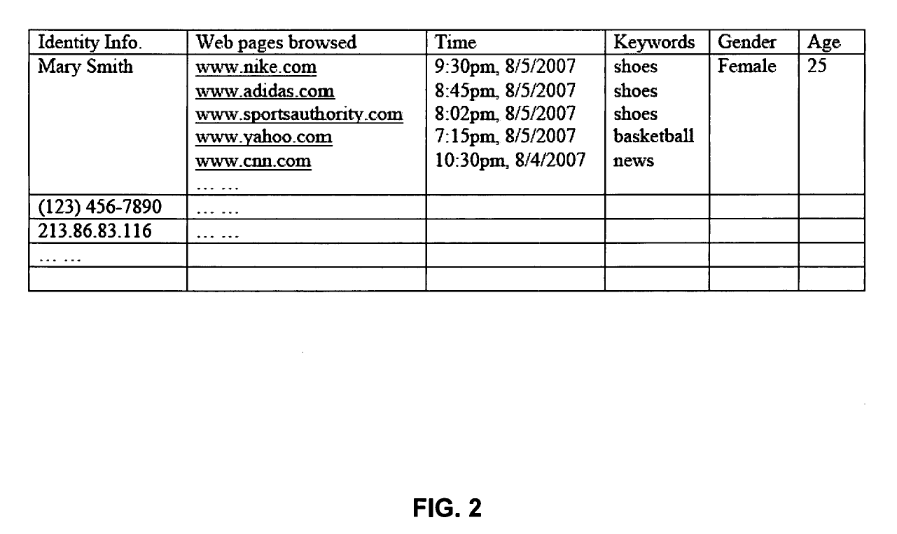

FIG. 2 illustrates an interest profile database 1031 according to one embodiment of the present invention. For each Internet user, the database 1031 may store his identity, web pages he has visited and the time of such visits. The Internet user's identity may be his name, or the IP address of his wireless telecommunication device. The server 103 may obtain the Internet user's name or other demographic information by collecting cookie files when he does on-line shopping or registers for services over the Internet with the Internet user's permission. The database may further store one or more keywords of the content of visited web pages, such as “car,” “running shoes,” or “mortgage”. The server 103 may obtain the keyword by crawling the visited web pages or collecting the user's input in a search box. In one embodiment, the data in the interest profile database may be set to expire after a certain period of time, e.g., 30 days, to provide a more accurate indication of the Internet users' current interests.

A registration information database 104 in FIG. 1 may store registration information of users of a mobile phone system, e.g., AT&T and T-Mobile. The registration information may include a user's name, mobile phone number and demographic information and may be stored when the user signs up for the service of the mobile phone system. The system shown in FIG. 1 may communicate with any number of such mobile phone databases, or other databases, for example, databases that store registration information for users of mobile Internet services such as Yahoo! Go™.

An information acquiring device 105 may be installed in or close to the electronic display device 101. The information acquiring device 105 may have a wireless-enabled receiving unit 1051, using one of the wireless technologies mentioned earlier or other wireless technologies, and a processing unit 1052. The wireless-enabled receiving unit 1051 may receive the identity information of a passerby from a wireless telecommunication device 102. If the identity information includes the passerby's name or the IP address of the passerby's wireless device, the processing unit 1052 may forward the identity information to the interest profile server 103 to obtain detailed information about that person, e.g., his recent browsing history and/or demographic information. If the identity information only includes a phone number, the processing unit 1052 may access the registration information database 104 to obtain the name of the passerby, and then forward the name to the interest profile server 103 to obtain detailed information about that person. The processing unit 1052 may also obtain the passerby's demographic information from the registration information database 104 or the interest profile server 103. The processing unit 1052 may then forward the detailed information to an advertisement server 106. If the identity information includes websites recently browsed by the passerby, the processing unit 1052 may forward such information to the advertisement server 106.

The advertisement server 106 may receive detailed information about a passerby from the information acquiring device 105, the interest profile server 103, or the user registration information database 104. Based on received detailed information about a passerby, the advertisement server 106 may select an advertisement targeted at that person. For example, if the browsing history information of a passerby indicates that the passerby recently browsed web pages about running shoes, the advertisement server 106 may select an advertisement about running shoes for this passerby. If the received detailed information further indicates that the passerby is a female, the advertisement server 106 may select an advertisement for female running shoes for this passerby. Although the interest profile server 103 and the advertisement server 106 are shown as two separate servers in FIG. 1, it should be understood that they may be combined into one server.

The information acquiring device 105 may communicate with the interest profile server 103 and user registration information database 104 via the Internet, or other telecommunication network, wired or wireless.

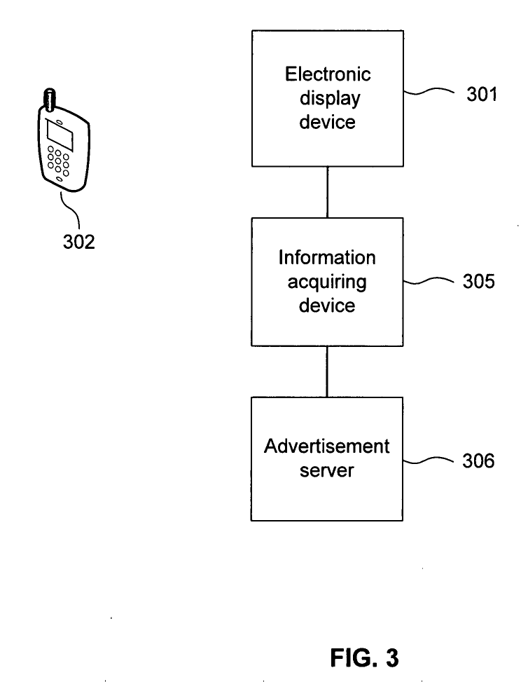

FIG. 3 illustrates a system for presenting advertisements targeted at passersby according to one embodiment of the present invention. In this embodiment, a wireless telecommunication device 302 is Internet capable. The wireless telecommunication device 302 may transmit cookie files as identity information regularly, e.g., every 10 seconds. The cookie files may include the wireless device's IP address, or web pages recently browsed. The cookie files may also include a user's demographic information, obtained when the user uses the wireless telecommunication device 302 to register for services or do on-line shopping.

A wireless enabled transceiver 305 may be installed in or close to an electronic display device 301. The transceiver 305 may receive the cookie files from a wireless telecommunication device 302 and send the cookie files to an advertisement server 306. The advertisement server 306 may select an advertisement according to information in the received cookie files, and have the selected advertisement displayed on the electronic display device 301.

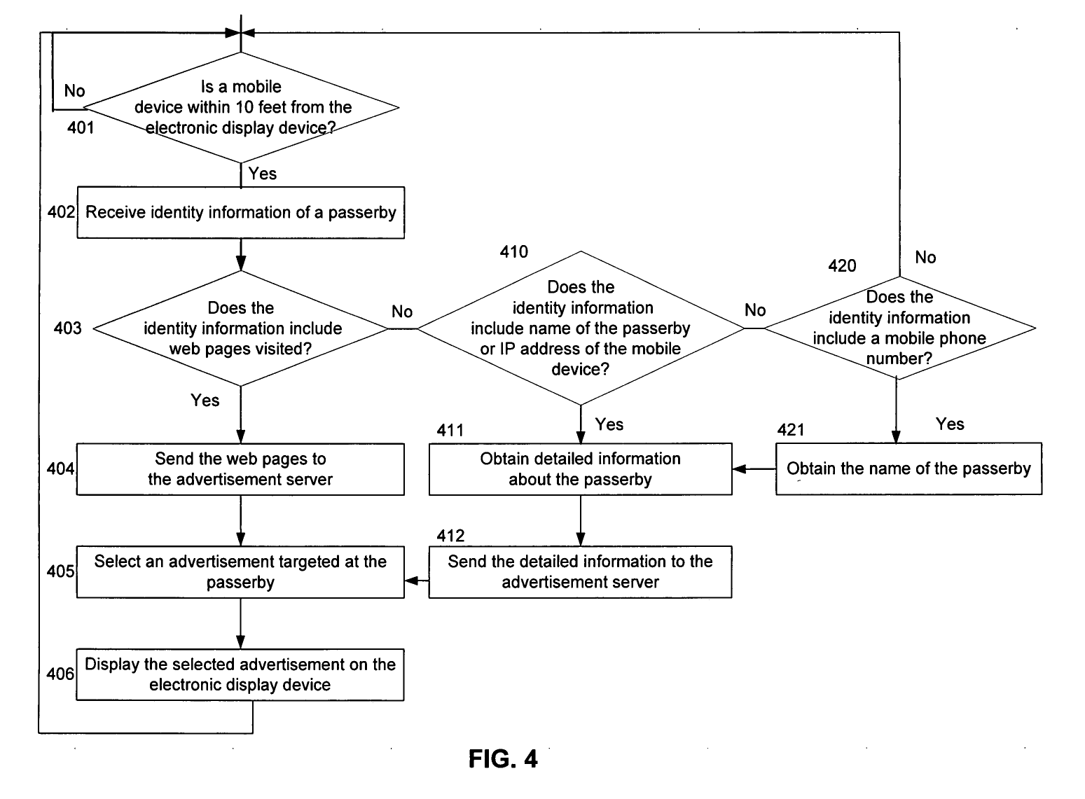

FIG. 4 illustrates a flow chart of a method for presenting advertisements targeted at passersby according to one embodiment of the present invention. The method will be described with reference to the system shown in FIG. 1. In one embodiment, an electronic display device 101 may be placed at a gas station, and the wireless-enabled receiving unit 1051 may be configured to detect wireless telecommunication devices within 10 feet. When there is more than one passerby near the wireless-enabled receiving unit 1051, the wireless-enabled receiving unit 1051 may pick the closest wireless telecommunication device for advertisement targeting. Alternatively, the advertisement server 106 may analyze interest profiles of all passersby near the wireless-enabled receiving unit 1051 and select an advertisement in which most passersby may be interested. In one embodiment, the wireless-enabled receiving unit 1051 may use a doppler antenna to detect wireless telecommunication devices on the screen side of the electronic display device 101, so that information about passersby on other sides of the device 101 will not interfere with the advertisement selecting process.

At 401, the information acquiring device 105 may detect whether a wireless telecommunication device 102 is moving toward the electronic display device 101 and is within, for example, 10 feet from the electronic display device.

At 402, the information acquiring device 105 may receive identity information of a passerby transmitted by a wireless telecommunication device 102 over a wireless network. The identity information may include the name and mobile phone number of the passerby, or cookie files. The cookie files may include the IP address of the wireless telecommunication device 102, or web pages the passerby visited. The identity information may further include the name of the carrier providing the mobile phone service.

At 403, the processing unit 1052 may determine whether the identity information includes information about web pages visited.

If yes, at 404, the processing unit 1052 may forward the web pages visited to the advertisement server 106. At 405, the advertisement server 106 may select an advertisement based on the visited web pages. At 406, the advertisement server 106 may have the selected advertisement displayed on the LCD 101.

If the identity information does not include web pages visited, it may be determined at 410 whether the identity information includes the name of a passerby or IP address of the wireless device. If yes, at 411, the processing unit 1052 may forward the identity information to the interest profile server 103 to obtain detailed information about the passerby. At 412, the detailed information may be sent to the advertisement server 106, either directly from the interest profile server 103, or via the information acquiring device 105. The process may then proceed to 405, so that the advertisement server 106 may select an advertisement for the passerby based on the detailed information. The selected advertisement may be displayed at 406.

If the identity information does not include the name of the passerby or the IP address of the wireless telecommunication device 102, it may be determined at 420 whether the identity information includes a mobile phone number. If yes, at 421, the processing unit 1052 may forward the mobile phone number to the registration information database 104 of the carrier providing the mobile phone service to find the name of the passerby. The process may then proceed to 411 to obtain detailed information about the passerby. After 412 and 405, a selected advertisement may be displayed at 406.

If the identity information does not include a mobile phone number either, the process may return to 401.

To make sure that the process of selecting and displaying a targeted advertisement for one passerby is not interrupted by other wireless telecommunication devices near the electronic display device 101, the processing unit 1052 may be configured to assign a predetermined time slot, e.g., 3 minutes, to one passerby. In one embodiment, the information acquiring device 105 may continuously monitor the movement of a wireless telecommunication device 102 after the process for selecting a targeted advertisement for the passerby carrying the wireless telecommunication device has started, and does not start the process for another passerby until it determines that the wireless telecommunication device is moving away from the electronic display device (Inventor, please confirm that the highlighted part is correct).

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of presenting targeted advertising, the method comprising:
wirelessly receiving identity information of a passerby when the passerby is in proximity to an electronic display device for displaying advertising;
using the identity information, determining advertising that may be relevant to the passerby; and
selecting the targeted advertising based on the determining.

2. The method of claim 1, wherein the identity information is selected from the group consisting of cookie files, a name of the passerby, an IP address and a mobile phone number.

3. The method of claim 1, wherein the wireless network is a PAN (personal area network).

4. The method of claim 1, wherein the using comprises obtaining detailed information selected from the group consisting of browsing history information and demographic information.

5. The method of claim 1, further comprising: having the targeted advertising displayed on the electronic display device.

6. The method of claim 4, further comprising: selecting the targeted advertising according to detailed information about more than one passerby.

7. The method of claim 1, further comprising: assigning a passerby a time slot for displaying the targeted advertising.

8. An information acquiring device, comprising:
a wireless signal receiving unit, for receiving identity information of a passerby when the passerby is in proximity to an electronic display device for displaying advertising; and
a processing unit, for receiving the identity information, obtaining detailed information about what the passerby might be interested in, so that targeted advertising can be selected for display on the electronic device.

9. The device of claim 8, wherein the wireless signal receiving unit receives the identity information via a PAN (personal area network).

10. The device of claim 8, wherein the identity information is selected from the group consisting of a name of the passerby, a mobile phone number, an IP address and cookie files.

11. The device of claim 8, wherein the detailed information is selected from the group consisting of browsing history information and demographic information.

12. The device of claim 8, wherein the processing unit further determines the passerby's moving direction.

13. The device of claim 8, wherein the processing unit further decides whether a time slot assigned to the passerby has expired.

14. The device of claim 8, further outputting the detailed information to enable selection of the targeted advertising.

15. The device of claim 8, further receiving a selected advertisement targeted at the passerby.

16. The device of claim 15, further having the selected advertisement displayed on the electronic display device.

17. A system for presenting targeted advertising to a passerby, the system comprising:
the device of claim 8; and.
an advertising server for selecting the targeted advertising according to the detailed information.

18. The system of claim 17, further comprising: an interest profile server for compiling the detailed information.

19. A computer program product comprising a computer-readable medium having instructions which, when performed by a computer, perform a method for presenting an advertisement targeted at a passerby, the method comprising:
wirelessly receiving identity information of a passerby when the passerby is in proximity to an electronic display device for displaying advertising;
using the identity information, determining advertising that may be relevant to the passerby; and
selecting the targeted advertising based on the determining.
